(19) United States
(12) Patent Application Publication
(10) Pub. No.: US 2026/0147420 A1
(43) Pub. Date: May 28, 2026

(54) KEYBOARD WITH ADJUSTABLE DEVICE HOLDER

(71) Applicant: Lenovo (United States) Inc., Morrisville, NC (US)

(72) Inventors: Brian William Wallace, Raleigh, NC (US); Joel Collins, Raleigh, NC (US); Brian Leonard, Chapel Hill, NC (US)

(21) Appl. No.: 18/958,588

(22) Filed: Nov. 25, 2024

(51) Int. Cl. G06F 3/02

(52) U.S. Cl. CPC G06F 3/0202

(57) ABSTRACT

A keyboard includes a case supporting keys positioned on a top surface of the case. An aperture is formed in a lower back portion of the case and extends laterally into the case. A tray is supported in the aperture and has a lip extending toward the top surface of the case. The tray adjustably disposed within the aperture to extend a selected distance away from the back portion of the case to form an adjustable width device slot for holding a device.

### BACKGROUND

Computer keyboards may include a slot to hold a device, such as a phone or tablet computer to allow users to view display on such devices while using the keyboard. The slot is usually formed in the keyboard on a far side of keys opposite a user.

### SUMMARY

A keyboard includes a case supporting keys positioned on a top surface of the case. An aperture is formed in a lower back portion of the case and extends laterally into the case. A tray is supported in the aperture and has a lip extending toward the top surface of the case. The tray adjustably disposed within the aperture to extend a selected distance away from the back portion of the case to form an adjustable width device slot for holding a device.

In various examples, the device may be a mobile phone or touchpad and may be held in portrait or landscape positions. The tray is adjustable to accommodate devices of different widths, either with or without cases.

### BRIEF DESCRIPTION OF THE DRAWINGS

FIG. 1 is a perspective view of an improved keyboard having an adjustable device holder according to an example embodiment.

FIG. 2 is a is a side view of a keyboard illustrating multiple positions of an adjustable device holder according to an example embodiment.

FIG. 3 is a cut away bottom view of a keyboard having an adjustable device holder according to an example embodiment.

FIG. 4 is a side view of a keyboard with a device engaged in a slot of a device holder according to an example embodiment.

FIG. 5A is a side cutaway partial view of a keyboard with a tray supported in an aperture of a case of the keyboard according to an example embodiment.

FIG. 5B is a side cutaway partial view of an alternatve keyboard with a tray supported in an aperture of a case of the keyboard according to an example embodiment.

FIG. 6 is a back cutaway partial view of a keyboard with a tray supported in an aperture of a case of the keyboard according to an example embodiment.

FIG. 7 is a perspective view of a keyboard supporting a device in an adjustable tray according to an example embodiment.

FIG. 8 is a perspective view of a keyboard supporting a device in an adjustable tray according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Computer keyboards may include a slot to hold a device, such as a phone or tablet computer to allow users to view display on such devices while using the keyboard. The slot is usually formed in the keyboard on a far side of keys opposite a user and is fixed in size. Such slots are typically injection molded into the keyboard and are not adjustable to accommodate devices having different widths, such as cellular phone that may vary in width as well as be encased by a plastic protective cases. Still further, such slots may not enable a user to adjust an angle of the phone in the slot for better viewing of device displays.

An improved keyboard includes an adjustable device holder. In one example, the adjustable device holder includes a tray that slides away from the keyboard a desired distance to accommodate devices of different widths, effectively creating adjustable width slots for the keyboard.

In the realm of modern computing, the integration of peripheral devices such as keyboards with additional functionalities has become increasingly significant. Users often require a seamless and efficient way to interact with multiple devices, including smartphones and tablets, while using their primary computing systems. This need has led to the development of various keyboard designs that incorporate additional features to enhance user convenience and productivity.

Existing solutions in the market often fall short in providing a versatile and adjustable mechanism for holding devices such as smartphones.

Many keyboards with integrated device holders lack the ability to accommodate a wide range of device thicknesses, leading to compatibility issues. Additionally, the fixed angles at which these holders position the devices may not be optimal for all users, resulting in discomfort and reduced usability. Furthermore, the inability to securely hold devices of varying thicknesses in both portrait and landscape orientations limits the functionality and adaptability of these keyboards.

An improved keyboard addresses these issues by incorporating an adjustable phone holder that can accommodate various device thicknesses and provide an optimal viewing angle. In one example, the phone holder adjusts to three different thicknesses, ensuring compatibility with a wide range of smartphones, including those with thin profiles, protective cases, and even thicker cases. The holder positions the devices at an angle between 60-70 degrees, which is ideal for user interaction. Additionally, the holder securely supports devices in both portrait and landscape orientations, enhancing the versatility and usability of the keyboard.

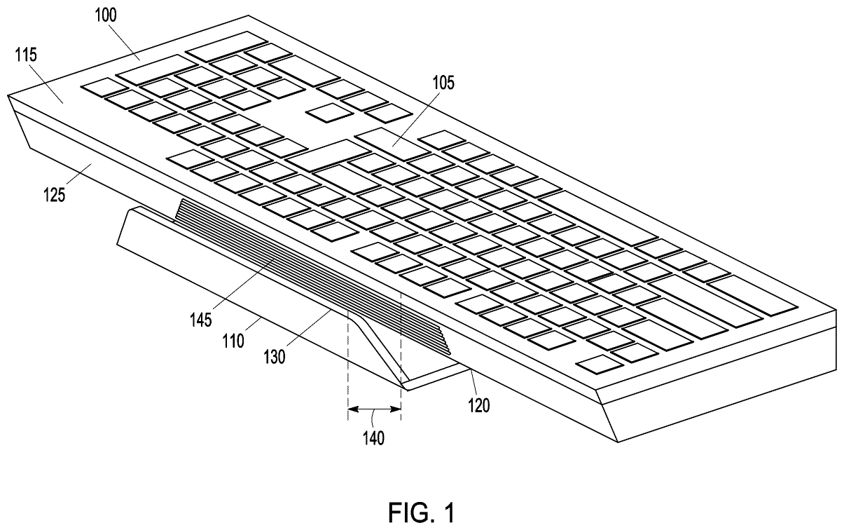

FIG. 1 is a perspective view of an improved keyboard 100 having keys 105 and an adjustable device holder or tray 110. The keyboard 100 includes a case 115 with an aperture 120 formed in a lower part of a keyboard back portion 125. The aperture 120 is an opening that extends laterally into the case 115. The tray 110 is slidably supported within the aperture 120. The tray 110 has a lip 130 extending toward a top surface 135 of the case 115.

The tray 110 is adjustably disposed within the aperture 120 to extend a selected distance 140 away from the back portion 125 of the case 115. This configuration allows the tray 110 to form an adjustable width device slot 145, which can accommodate devices of varying thicknesses. This adjustability provides flexibility for users to securely hold different devices, such as phones with or without cases, in both portrait and landscape orientations, enhancing the usability and versatility of the keyboard.

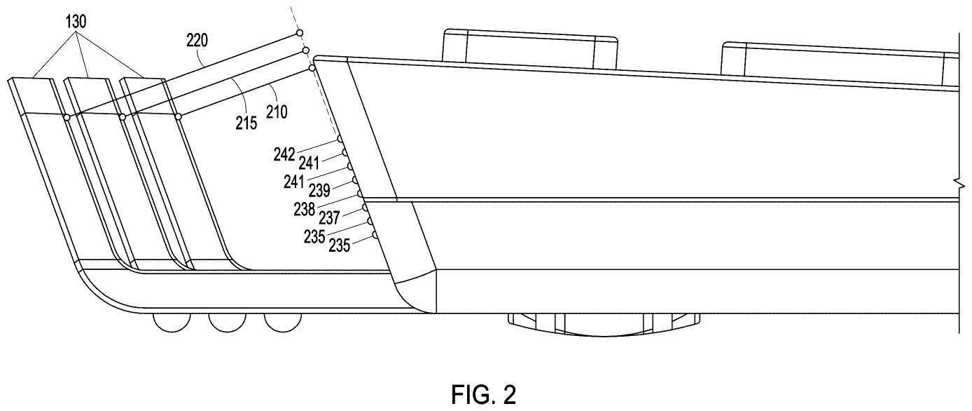

FIG. 2 is a is a side view of the keyboard 100 illustrating multiple positions of the tray 110 creating different device slot 145 widths. In one example, current mobile or cellular phones have a thickness of approximately 9 mm. Phones with a case have an average thickness of approximately 11 mm, and phones with a thicker case have an average thickness of 15 mm. Various positions of lip 130 are shown forming a device slot 145 having a width of 9.25 mm at 210, a width of 12.75 mm at 215, and a width of 16.25 mm at 220.

In one example, the lip 130 extends from a bottom 225 of the tray 110 and is angled away from a vertical line orthogonal to a surface on which the keyboard is placed by about 20-30 degrees to tilt a device 20-30 degrees, allowing ease of viewing of a display of the device by a user of the keyboard.

Multiple ribs 235, 236, 237, 238, 239, 240, 241, and 242 are shown formed on the back portion 125 of the case 115. The ribs are configured to contact an edge of a device inserted into the slot 145. In one example, the ribs extend horizontally along the back portion 125 of the case 115 to contact a horizontally disposed edge of an inserted device. Rib 235 is closest to the bottom 225 of the tray 110 to secure the device at an angle close to the angle of the lip 130. The device can also be partially inserted into the slot 145 to have its lower edge contact higher ribs, each successive ridge providing a further tilt of the device farther from a user of the keyboard 100. while 8 ribs are shown, further or fewer ribs may be provided.

Keyboard 100 may include one or more feet 250 to space the keyboard 100 from a surface on which the keyboard is placed. Tray 110 may include a foot 255 to support the tray 110 when extended away to form the slot 145. The foot 255 may have dimensions similar to the feet 250 to space the tray in a neutral vertical position with respect to the keyboard 100 aperture 120.

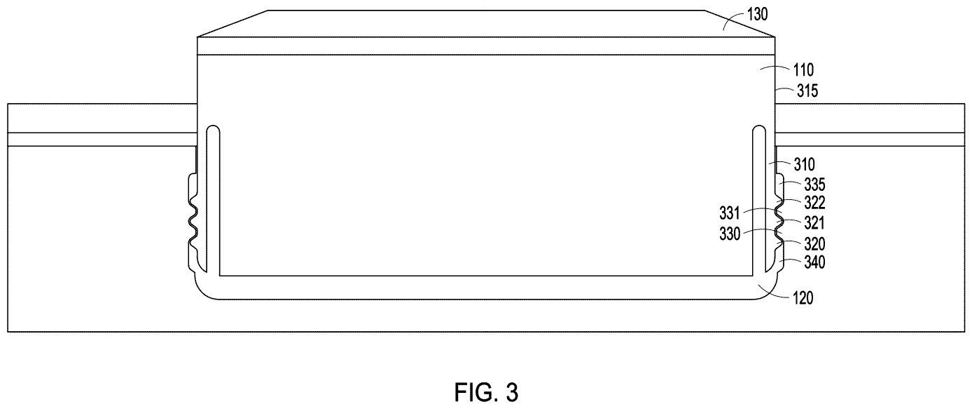

FIG. 3 is a cut away bottom view of the keyboard 100. A bottom 300 of the keyboard is shown with the tray 110 shown in an open position and supported within the aperture 120. In one example, tray 110 includes an arm 310 on one side 315 of the tray 110. The arm 310 is spaced from a bottom side 315 of the tray 110 and acts as a spring. Arm 310 includes three protrusions indicated at 320, 321, and 322. The protrusions are configured to engage mating protrusions 330 and 331 positioned in a cutout 335 in a side 340 of the aperture 120 of keyboard 100. The arm 310 flexes laterally to enable the matting protrusions to retentatively engage each other at different open positions of the tray 110 facilitating the provision of different slot widths. Only one side of the tray 110 is shown. The other side of the tray 110 and aperture 120 may include the same components in a mirrored or otherwise configuration to provide a similar function.

The position shown provides a medium width slot. To provide other width slots, the protrusions are configured to mate in different positions.

The protrusions also provide retentive force to close the tray wherein the lip 130 mates with a recess in the back portion 125 of the keyboard to provide a flush profile with the back portion 125. While the protrusions are shown as rounded, other shapes, such as triangles that permit movement and retentive positions of the tray 110 may be used as a means of adjusting the size of the slot. Further means of adjusting and holding the tray 110 in an selected open position include friction fitting the tray 110 within the

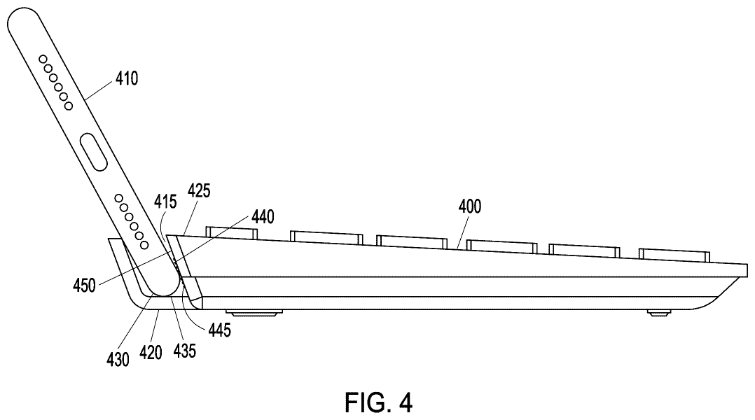

FIG. 4 is a side view of a keyboard 400 with a device 410 engaged in a slot 415 formed by a tray 420 extended from a case 425 of the keyboard 400. The device 410 is shown with a bottom portion 430 engaging a bottom 435 of the tray 420 and a side 440 contacting one or more ribs 445 on a back portion 450 of the keyboard 400.

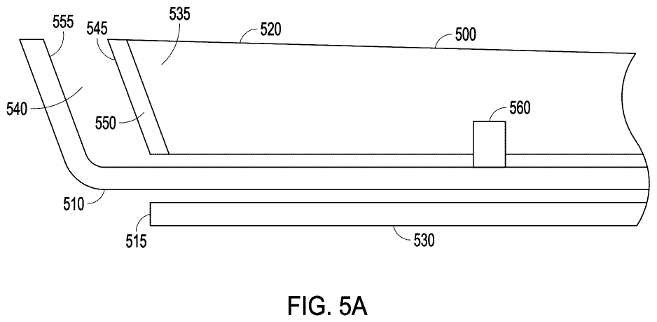

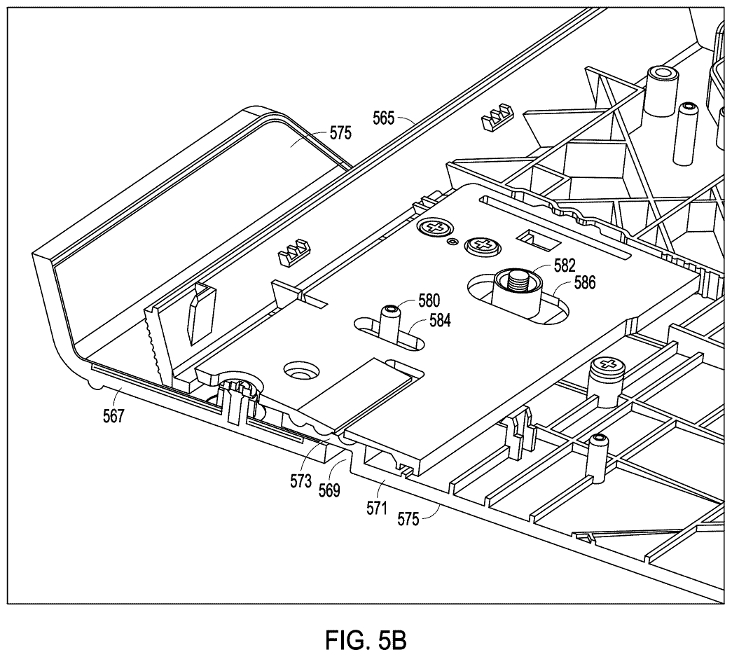

FIG. 5A is a side cutaway partial view of a keyboard 500 with a tray 510 supported in an aperture 515 in a case 520 of the keyboard 500. The aperture 515 is formed between a bottom 530 of the case 520 and a main body 535 of the case 520. The tray 510 is formed in one of multiple open positions forming a slot 540 for holding a device in a desired position on the keyboard 500. A back portion 545 of the keyboard 500 includes a recess 550 configured to enable a lip 555 of the tray 510 to be flush with the back portion 545 in a closed position. In one example, the tray 510 may include one or more protrusions 560 extending from a top surface of the tray 510 through the aperture and an elongated guide slot in in the case to help guide lateral movement of the tray while forming different widths for the slot 540. The combination of protrusions 560 and guide slots may also be used to prevent removal of the tray 510 if desired.

FIG. 5B is a side cutaway partial view of a keyboard 565 with a tray 567 supported in an aperture 569 of a case 571 of the keyboard 565 according to an example embodiment. The aperture 569 is formed in a cutout 573 of a bottom 575 of the case 571. The tray 567 is formed in one of multiple open positions forming a slot 575 for holding a device in a desired position on the keyboard 565. In one example, the tray 510 may include one or more protrusions 580, 582 extending from a top surface of the tray 567 through corresponding elongated guide slots 584, 586 in in the case to help guide lateral movement of the tray while forming different widths for the slot 575. The combination of protrusions 580, 582 and guide slots 584, 586 may also be used to prevent removal of the tray 567 if desired.

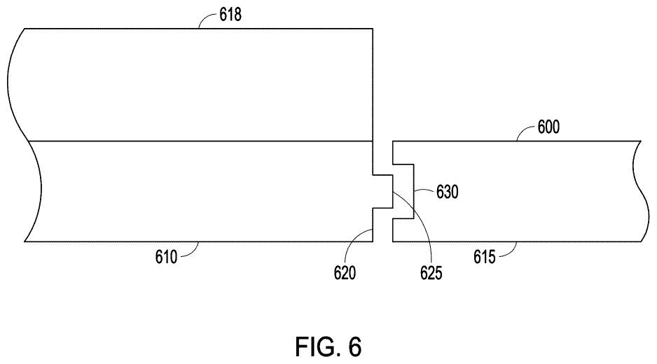

FIG. 6 is a back cutaway partial view of a keyboard 600 with a tray 610 supported in an aperture of a case 615 of the keyboard 600. The tray 610 has a lip 618 and a side 620 that is keyed with a side of the case 615. In one example, the keying comprises a ridge and slot or groove arrangement. While positions of the ridge and slot or grove may be interchangeable, the side 620 of the tray 610 is shown with a ridge 625 engaging with a slot or groove 630 in the side of the case 615. The ridge 625 and slot or groove 630 provide resistance to vertical movement of the tray in various open position of the tray 610.

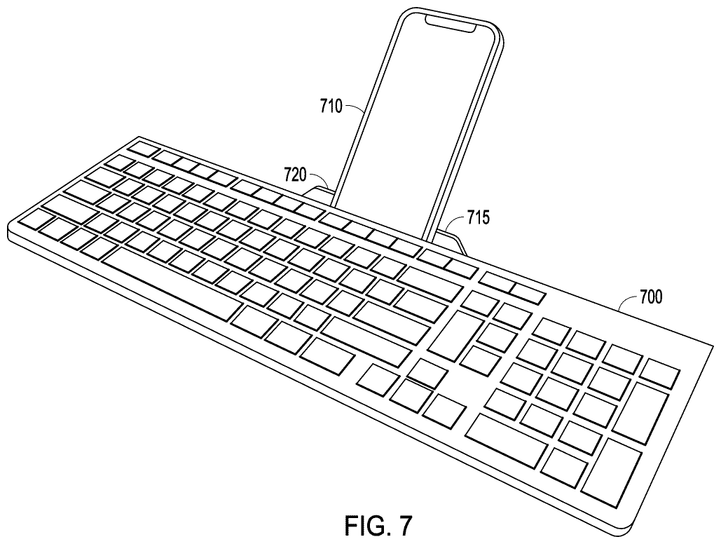

FIG. 7 is a perspective view of a keyboard 700 supporting a device 710 in an adjustable tray 715. The tray 715 is shown in an open position to provide a slot 720 supporting the device 710 in a portrait position. A width of the tray 715 may be varied to hold a phone or a tablet, or multiple phones or tablets in different examples to enable a user to position the phone or tablet in a desired position for each of viewing a display of the phone or tablet. In further examples, multiple trays may be provided of the same or varying widths.

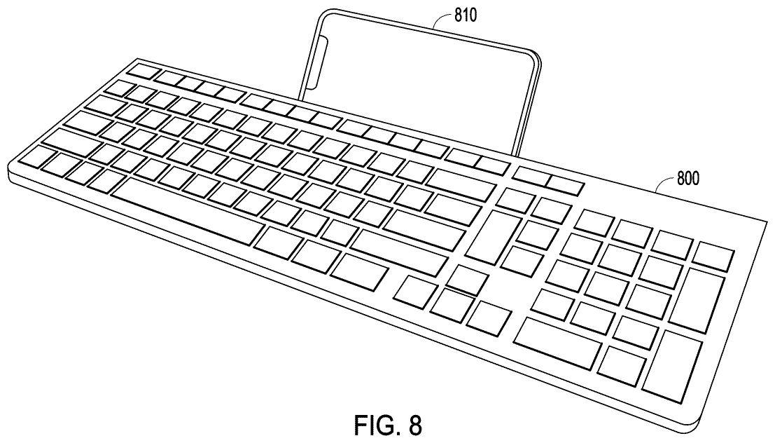

FIG. 8 is a perspective view of a keyboard 800 supporting a device 810 in an adjustable tray. The adjustable tray is not illustrated as it is hidden behind the device 810.

### EXAMPLES

1, A keyboard includes a case supporting keys positioned on a top surface of the case. An aperture is formed in a lower back portion of the case and extends laterally into the case. A tray is supported in the aperture and has a lip extending toward the top surface of the case. The tray adjustably disposed within the aperture to extend a selected distance away from the back portion of the case to form an adjustable width device slot for holding a device.

2. The keyboard of example 1 wherein the lip extends toward the top surface of the case an angle of between 20-30 degrees from a vertical line orthogonal to a surface on which the keyboard is placed.

3. The keyboard of example 2 wherein the case includes a recess configured to mate with the lip of the tray in response to a length of the tray being fully inserted into the aperture.

4. The keyboard of example 3 wherein the recess includes a ribbed surface having multiple spaced ribs extending in parallel to a width of the tray and configured to engage with a device inserted into the slot.

5. The keyboard of any of examples 1-4 wherein the aperture and tray include spring loaded mating protrusions to provide fixed widths of the device slot.

6. A computer keyboard includes an adjustable device holder integrated into the keyboard, wherein the device holder is configured to open to three different positions to different width device slots to accommodate devices having different thicknesses, wherein the device holder is further configured to hold phones at an angle of between 20-30 degrees from a vertical line orthogonal to a surface on which the computer keyboard is placed, and wherein the device holder is capable of holding devices in different orientations.

7. The keyboard of example 6, wherein device holder includes a lip extending toward a top surface of the keyboard at an angle of between 20-30 degrees from a vertical line orthogonal to a surface on which the keyboard is placed.

8. The keyboard of any of examples 6-7, wherein the device holder is supported in a keyboard aperture and include spring-loaded mating protrusions to provide fixed width device slots.

9. The keyboard of example 8, wherein the device holder comprises a tray having multiple adjustable positions to accommodate different device thicknesses.

10. The keyboard of example 9, wherein the tray is removable from the aperture for cleaning or replacement.

11. The keyboard of example 10, and further comprising a locking mechanism to secure the tray in a selected position.

12. The keyboard of example 11, wherein the tray has a non-slip surface to prevent devices from sliding.

13. The keyboard of any of examples 10-12, wherein the tray is configured to hold a device in both portrait and landscape orientations.

14. A keyboard includes a case, keys supported by the case and positioned on a top surface of the case, and an aperture formed in a lower back portion of the case extending laterally into the case and configured to support a tray in the aperture, the tray having a lip extending toward the top surface of the case, the tray adjustably disposed within the aperture to extend a selected distance away from the back portion of the case to form an adjustable width device slot.

15. The keyboard of example 14 wherein the lip extends toward the top surface of the case an angle of between 20-30 degrees from a vertical line orthogonal to a surface on which the keyboard is placed.

16. The keyboard of example 15 wherein the case includes a recess configured to mate with the lip of the tray in response to a length of the tray being fully inserted into the aperture.

17. The keyboard of example 16 wherein the recess includes a ribbed surface having multiple spaced ribs extending in parallel to a width of the tray and configured to engage with a device inserted into the slot.

18. The keyboard of any of examples 14-17 wherein the aperture and tray include spring loaded mating protrusions to provide fixed widths of the device slot.

19. The keyboard of any of examples 14-18 and further comprising means for securing the tray in the aperture.

20. The keyboard of example 19 wherein the tray includes a non-slip surface to prevent device movement.

Although a few embodiments have been described in detail above, other modifications are possible. Other embodiments may be within the scope of the following claims.

1. A keyboard comprising:
a keyboard case;
keys supported by the keyboard case and positioned on a top surface of the keyboard case;
an aperture formed in a lower back portion of the keyboard case extending laterally into the keyboard case; and
a tray supported in the aperture, the tray having a lip extending toward the top surface of the keyboard case, the tray adjustably disposed within the aperture to extend a selected distance away from the back portion of the keyboard case to form an adjustable width device slot

2. The keyboard of claim I wherein the lip extends toward the top surface of the keyboard case an angle of between 20-30 degrees from a vertical line orthogonal to a surface on which the keyboard is placed.

3. The keyboard of claim 2 wherein the keyboard case includes a recess configured to mate with the lip of the tray in response to a length of the tray being fully inserted into the aperture.

4. The keyboard of claim 3 wherein the recess includes a ribbed surface having multiple spaced ribs extending in parallel to a width of the tray and configured to engage with a device inserted into the slot.

5. The keyboard of claim 1 wherein the aperture and tray include spring loaded mating protrusions to provide fixed widths of the device slot.

6. A computer keyboard comprising:
a keyboard case;
keys supported by the keyboard case and positioned on a top surface of the keyboard case,
an adjustable device holder integrated into the keyboard case;
wherein the device holder is configured to open to three different positions to different width device slots to accommodate devices having different thicknesses;
wherein the device holder is further configured to hold phones at an angle of between 20-30 degrees from a vertical line orthogonal to a surface on which the computer keyboard is placed; and
wherein the device holder is capable of holding devices in different orientations.

7. The keyboard of claim 6, wherein device holder includes a lip extending toward a top surface of the computer keyboard at an angle of between 20-30 degrees from a vertical line orthogonal to a surface on which the computer keyboard is placed.

8. The keyboard of claim 6, wherein the device holder is supported in a keyboard case aperture and includes spring-loaded mating protrusions to provide fixed width device slots.

9. The keyboard of claim 8, wherein the device holder comprises a tray having multiple adjustable positions to accommodate different device thicknesses.

10. The keyboard of claim 9, wherein the tray is removable from the aperture for cleaning or replacement.

11. The keyboard of claim 10, and further comprising a locking mechanism to secure the tray in a selected position.

12. The keyboard of claim 11, wherein the tray has a non-slip surface to prevent devices from sliding.

13. The keyboard of claim 10, wherein the tray is configured to hold a device in both portrait and landscape orientations.

14. A keyboard comprising:
a keyboard case;
keys supported by the keyboard case and positioned on a top surface of the keyboard case; and
an aperture formed in a lower back portion of the keyboard case extending laterally into the keyboard case and configured to support a tray in the aperture, the tray having a lip extending toward the top surface of the keyboard case, the tray adjustably disposed within the aperture to extend a selected distance away from the back portion of the case to form an adjustable width device slot.

15. The keyboard of claim 14 wherein the lip extends toward the top surface of the keyboard case an angle of between 20-30 degrees from a vertical line orthogonal to a surface on which the keyboard is placed

16. The keyboard of claim 15 wherein the keyboard case includes a recess configured to mate with the lip of the tray in response to a length of the tray being fully inserted into the aperture.

17. The keyboard of claim 16 wherein the recess includes a ribbed surface having multiple spaced ribs extending in parallel to a width of the tray and configured to engage with a device inserted into the slot.

18. The keyboard of claim 14 wherein the aperture and tray include spring loaded mating protrusions to provide fixed widths of the device slot.

19. The keyboard of claim 14 and further comprising means for securing the tray in the aperture.

20. The keyboard of claim 19 wherein the tray includes a non-slip surface to prevent device movement.
